(19) United States
(12) Patent Application Publication
(10) Pub. No.: US 2026/0358126 A1
(43) Pub. Date: Nov. 12, 2026

(54) OPTICAL SYSTEM FOR RESONATOR

(71) Applicants: THALES, MEUDON (FR); EXAIL, SAINT-GERMAIN-EN-LAYE (FR)

(72) Inventors: Frédéric SEGUINEAU, CHATELLERAULT (FR); Aurélien BOUTIN, CESTAS (FR)

(21) Appl. No.: 19/125,701

(22) PCT Filed: Nov. 27, 2023
(86) PCT No.: PCT/EP2023/083150

§ 371 Date: Apr. 29, 2025

(30) Foreign Application Priority Data
Dec. 1, 2022 (FR) FR2212626

(51) Int. Cl. G01C 19/66; G02B 6/12

(52) U.S. Cl. CPC G01C 19/661; G02B 6/12007; G02B 2006/12104; G02B 2006/12114

(57) ABSTRACT

An optical system intended to be coupled to an optical resonator, wherein the optical resonator includes a first port and a second port and being configured so that a first optical signal and a second optical signal circulate in opposite directions, the optical system including a first prism and a second prism respectively having: a first external face and a second external face, which faces are configured to reflect a first incident optical signal and a second incident optical signal, respectively, before their injection into the first port and the second port, respectively, a first internal face and a second internal face facing each other, the first and second prisms further being configured so that the internal part of the common path makes, with each of the internal faces, an angle equal to Brewster's angle.

### CROSS-REFERENCE TO RELATED APPLICATIONS

This application is a National Stage of International patent application PCT/EP2023/083150, filed on Nov. 27, 2023, which claims priority to foreign French patent application No. FR 2212626, filed on Dec. 1, 2022, the disclosures of which are incorporated by reference in their entireties.

### FIELD OF THE INVENTION

The present invention relates to the field of RFOGs (RFOG standing for Resonant Fiber-Optic Gyroscope).

### BACKGROUND

In RFOGs, the resonant cavity OC0 comprises an optical fiber wound into a coil (called the optical resonator coil) having a radius R, and two waves 11a and 11b propagate through the resonator in opposite directions: the clockwise or CW direction and counter-clockwise or CCW direction, respectively.

One example of an RFOG is illustrated in FIG. 1. The two optical signals 11a and 11b result from incident optical signals 10a and 10b generated by a coherent source system LSS, respectively, and are injected into the two ports P10 and P20 of the ring resonator, respectively. Injection is achieved via an optical coupling system OPS0. The optical coupling system also comprises an optical system 2 for closing the resonator loop, and the signals 11a and 11b then turn in the closed cavity.

The optical coupling system also makes it possible to collect the beams Ta and Tb transmitted by the cavity. The source system LSS also comprises at least two detectors PhD1 and PhD2 that detect Ta and Tb, respectively, and the electrical signals generated by the two detectors are used to servo-control the frequency of the signals 10a and 10b. Optionally, alternatively or in combination, the signals Ra and/or Rb reflected by the cavity (i.e. the interference between the beam passed into the cavity and the incident beam) are collected and used via detectors PhD3 and PhD4. The source system LSS is connected to a processing unit PU that determines an angle of rotation Q about a Z-axis parallel to the axis of the coil and perpendicular to the plane of the resonator based on the signals extracted from the resonator.

The principle of measurement with a gyrometer is briefly recalled below. The Sagnac effect is used to take measurements of rotation. The optical signals in the cavity have a respective frequency fa and fb that meets the condition for resonance, i.e. a frequency that is a multiple of the free spectral range. In the presence of an angular rotation the frequencies of the waves 11a and 11b circulating in the cavity have a frequency difference Δf proportional to the velocity of rotation. For a fiber of length L wound with N turns of radius R (L=2pRN), it may be demonstrated that the frequency difference Δf is expressed by:

$$Δ f = \frac{2 R}{n λ} \cdot \dot{θ}$$

where n is the index of the fiber and \dot{θ} is the velocity of rotation.

To measure this difference Δf, (transmitted or reflected) beams sampled from the cavity are collected and typically two servo-control mechanisms are used to track the resonant frequencies of the cavity over time and thus to measure Δf.

The publication by Sanders et al. “Development of compact resonator fiber optic gyroscopes” (IEEE International Symposium on Inertial Sensors and Systems, pp. 168-170, 2017) describes an RFOG with a hybrid cavity formed with a polarization-maintaining fiber coupled to a silicon optical bench forming the optical coupling system. The optical bench is composed of 6 ball lenses (for collimating and focusing laser beams), four mirrors (serving as input and/or output couplers for the various beams injected into the cavity) and two polarizing cube beamsplitters (for polarization control). In this gyrometer the source system comprises a master laser and two slave lasers that are phase locked to the master, these generating three waves at three different frequencies, and it is the difference in emission frequency between the two slave lasers that is proportional to the velocity of rotation of the cavity.

However, gyrometers using a coiled fiber-optic cavity formed with a conventional fiber with a silica core run into problems with instability and temperature resistance due to the occurrence of the Kerr effect in the fiber in the presence of counter-propagating waves. For this reason, in the last decade RFOGs using new-generation fibers and mainly two families of fibers, the PBGFs (PBGF standing for Photonic Band Gap Fiber) and HCFs (HCF standing for Hollow Core Fiber), have been studied. In the latter the core consists of air or vacuum and thus the problem due to the Kerr effect is avoided.

The publication by Ravaille et al. “Rotation measurement using a resonant fiber optic gyroscope based on Kagome fiber” (Applied Optics, Vol. 58 No. 9 Mar. 2019) describes such a gyrometer the architecture of which is illustrated in FIG. 2.

The two frequencies fb and fa are generated using a laser Las0 that is frequency shifted by acousto-optic modulators AOM1 and AOM2 followed by a phase modulator PM1, PM2. The waves transmitted by the cavity Ta and Tb are collected by the photodetectors PhD1 and PhD2. The two resonant frequencies are tracked via an electronic servo-control mechanism comprising a modulation at a frequency fm,1 and fm,2, and a low-pass filter LPF1, LPF2 that generates an error signal that drives the modulator via a corrector PID1, PID2. The apparatus used to generate the signals 10a and 10b is fiber-optic and collimators COL allow the beams to be manipulated in free space on exiting the fiber optics. Likewise, collimators are positioned at the exit of the fiber of the resonator OC0. The optical system OPS0 used for cavity coupling (and loop closure) here is a free-space system and comprises two mirrors M10 (93% reflection) and M20 (100% reflection). Polarizers and Lλ/2 plates placed on the optical paths of the waves 10a and 10b before entry into the system OPS0 make it possible to obtain the polarization desired for injection, and Lλ/2 plates placed in front of the ports P10 and P20 make it possible to modify the polarization entering the HCF because particular entrance polarizations are required to guarantee the best propagation through the fiber. The HCF used here is of IC HC-PCF type (IC HC-PCF standing for Inhibited Coupling, Hollow Core-Photonic Crystal Fiber). In this type of fiber the hollow core is encircled by a microstructure forming a photonic crystal (wrap-around Bragg grating).

The publication by Sanders et al. “Hollow-core resonator fiber optic gyroscope using nodeless anti-resonant fiber” (Optics Letters, Vol. 46 No. 1 2021) describes another example of an RFOG employing a hollow fiber, here of NANF type (NANF standing for Nested Anti-resonant Nodeless Fiber). This gyrometer is a 3-wave gyrometer as in the aforementioned publication by Sanders et al., and the processing uses a modulation/demodulation type approach. In this publication, the free-space optical coupling system uses polarizing cube beamsplitters.

Three-wave gyrometers in which two collinear CW waves and one CCW wave are for example injected into the cavity also exist.

However, all these HCFs have their own drawbacks. An effective coupler has never been developed (meaning that free-space loop closure is required), they have high linear losses and high losses are sustained coupling to the fiber due to its small core and to mode matching being tricky. These drawbacks make it difficult to produce a cavity without excessive losses.

Furthermore, the performance of resonant-cavity gyrometers is very sensitive to various perturbations in the cavity, including variations in polarization intra-cavity. It is necessary to match the polarization circulating in free space with the polarization of the mode circulating in the cavity. It is therefore essential to properly control and set the polarization in the cavity. Maintaining a specific polarization over multiple turns in the HCF is also a challenge because HCFs that effectively maintain polarization (polarization-maintaining fibers also being called PANDA fibers) have not yet been developed. Furthermore, the counter-propagating waves must have a given polarization with very high precision, because otherwise measurement errors will result. A difference in polarization between the two counter-propagating waves generates a non-reciprocity between the two optical paths, this distorting the measurement.

In order to attempt to solve the problems with polarization, document EP3514491 provides a 3-wave gyrometer architecture with an optical coupling system comprising four mirrors, four ball lenses and two polarizing cube beamsplitters. It also uses two polarizers, each polarizer being common to the wave entering the optical coupling system and to the one injected into the fiber (intra-cavity). Technological realization of this configuration is not a given and the optical arrangement of these polarizers in the optical coupling system is unclear.

### SUMMARY OF THE INVENTION

One aim of the present invention is to overcome the aforementioned drawbacks, by providing a new optical architecture for an optical coupling system for injecting the two incident beams 10a and 10b into the resonator and closing the loop of the latter, and allowing the polarization in the cavity to be controlled.

One subject of the present invention is an optical system intended to be coupled to an optical resonator, the optical resonator comprising a first port and a second port and being configured so that a first optical signal and a second optical signal circulate in opposite directions, the optical system comprising:
a first prism and a second prism, which prisms are placed on a path through free space common to the first and second signals between the two ports, the first prism and second prism respectively having:
   a first external face and a second external face, which faces are configured to reflect a first incident optical signal and a second incident optical signal, respectively, before their injection into the first port and the second port, respectively,
   a first internal face and a second internal face facing each other, part of the common path located between the two internal faces being called the internal part of the common path,
the first and second prisms further being configured so that the internal part of the common path makes, with each of the internal faces F1int, F2int, an angle equal to Brewster's angle.

According to one embodiment, the first prism and the second prism have a first vertex and a second vertex, respectively, having a first angle and a second angle that are different, respectively.

According to another embodiment, the first prism and the second prism have a first vertex and a second vertex, respectively, having a first angle and a second angle that are identical, respectively.

According to a first variant, the first and second internal faces of the prisms are arranged symmetrically about a plane perpendicular to the plane of the common path.

According to a second variant, the first and second prisms are arranged head to tail.

According to one embodiment, the first and second prisms are triangular-based.

According to one embodiment, the first and second prisms are double prisms, each double prism having an additional vertex having an angle identical to the angle of the corresponding vertex.

According to one embodiment, the first and/or second prisms are truncated.

According to one embodiment, the first angle is determined so as to obtain a predetermined first coefficient of reflection for the first optical signal from the first external face and a predetermined second coefficient of reflection for the second optical signal from the second external face, respectively.

The invention also relates to a gyrometer comprising:
a coherent source system configured to generate the first incident optical signal and the second incident optical signal;
the optical resonator;
an optical system according to the invention coupled to the optical resonator,
the source system comprising at least a first photodetector and a second photodetector, which photodetectors are configured to detect optical signals extracted from said resonator via said optical system, and control and servo electronics,
a processing unit configured to determine an angle or a velocity of rotation about a Z-axis based on the electrical signals generated by said detectors.

According to one embodiment, the resonator is a cavity comprising at least three mirrors.

According to another embodiment, the resonator is an optical fiber.

According to one embodiment, the fiber is wound into a coil.

According to one embodiment, the optical fiber is a hollow-core fiber.

The following description presents a number of examples of embodiment of the device of the invention: these examples do not limit the scope of the invention. These embodiments not only contain features that are essential to the invention but also additional features associated with the embodiments in question.

### BRIEF DESCRIPTION OF THE DRAWINGS

The invention will be better understood and other features, aims and advantages thereof will become apparent from the following detailed description, which is provided with reference to the appended drawings, which are given by way of non-limiting examples and in which:

FIG. 1, which has already been mentioned, illustrates a schematic diagram of the operation of a gyrometer.

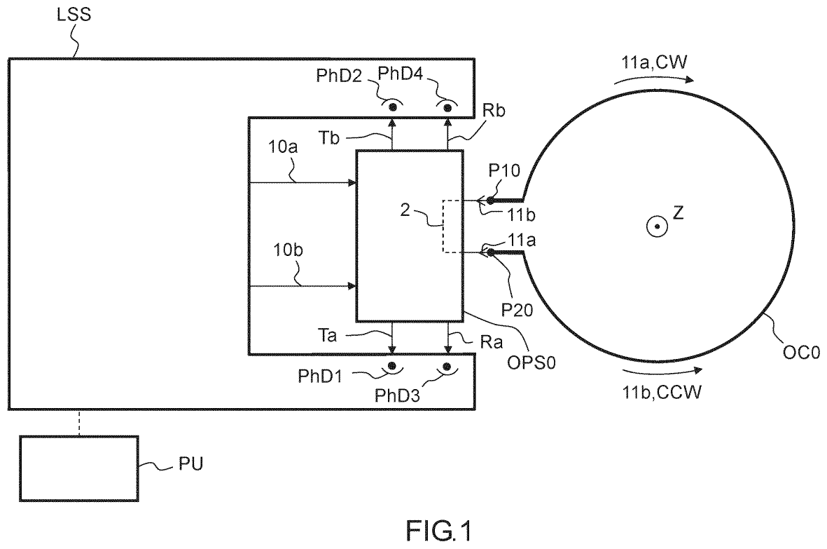

FIG. 2, which has already been mentioned, illustrates the architecture of a gyrometer with a HCF fiber-optic cavity according to the state of the art.

FIG. 3 illustrates the characteristics of Brewster's angle.

FIG. 4 illustrates an optical system according to the invention in a first configuration in which the internal faces of the prisms are arranged symmetrically, and according to a first variant in which the prisms are triangular-based, for the optical path of the generic CW signal.

FIG. 5 illustrates the optical system according to the invention of FIG. 4 for the optical path of the generic CCW signal.

FIG. 5A illustrates the optical system according to the invention coupled to a mirror cavity.

FIG. 6 illustrates an optical system according to the invention in a second configuration in which the first and second prisms are arranged head to tail.

FIG. 7 illustrates an optical system according to the invention according to a second variant in which the first and second prisms are double prisms, and in the first configuration (symmetrical arrangement).

FIG. 8 illustrates an optical system according to the invention according to the second variant in which the first and the second prisms are double prisms, and in the second configuration (head-to-tail arrangement).

FIG. 9 illustrates a gyrometer according to the invention.

### DETAILED DESCRIPTION

In the remainder of the description of the invention, the notations of the incident optical signals 10a, 10b and of the optical signals circulating in the resonator 11a, 11b have the same meaning as in the state of the art.

The invention relates to an optical system OPS intended to be coupled to an optical resonator OC. The system OPS injects the exterior beams 10a and 10b (incident optical signals) into the resonator and closes the resonator loop.

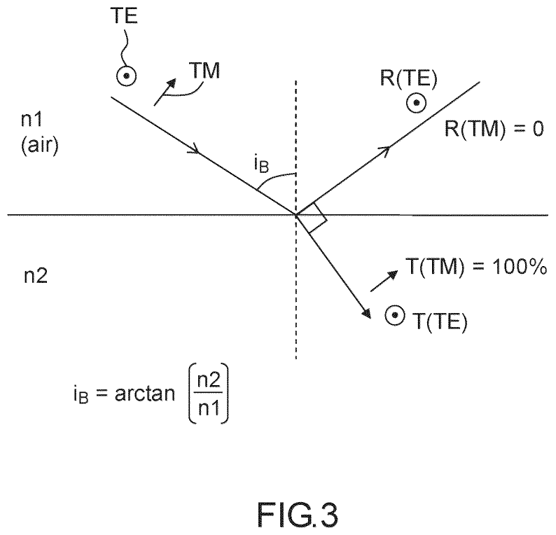

The invention is based on the use of prisms operating at Brewster's angle, the main characteristics of which are schematically shown in FIG. 3. When a light wave is reflected at a dioptric interface between two media of respective indices n1 and n2, the Fresnel coefficients R (reflectance) and T (transmittance) are calculated, for a given angle of incidence on the first medium and for each TE (plane perpendicular to the plane of incidence) and TM (in the plane of incidence) polarization, according to the well-known laws of optics. For a particular angle of incidence called Brewster's angle i_{B}, the TM polarization is entirely transmitted, i.e. its reflectance is zero. For a dioptric interface between air and glass with a refractive index of 1.5, Brewster's angle of incidence in air i_{B}=56.3°.

Thus at Brewster's angle the TM polarization will be transmitted from one medium to the other with a high degree of purity and without loss.

The optical system OPS according to the invention is a coupling system suitable for a resonator in which counter-propagating optical signals circulate. The resonator comprises two ports between which the counter-propagating optical signals propagate in free space. This optical path in free space between the two ports is called the common path TC. The system OPS may be implemented in any type of gyrometer having a cavity of this type. It is thus compatible with a 2- or 3-wave gyrometer, with a source system comprising one or more lasers and with all the various types of servo-control mechanisms known to those skilled in the art. It is suitable for a mirror cavity and for a fiber-optic cavity, whether the fiber of the latter is coiled or not or has a solid core or a hollow core, though the system is particularly advantageous when it is a question of the latter type of fiber. The optical system according to the invention is an alternative solution to the various optical coupling systems known to those skilled in the art, examples of which were given above.

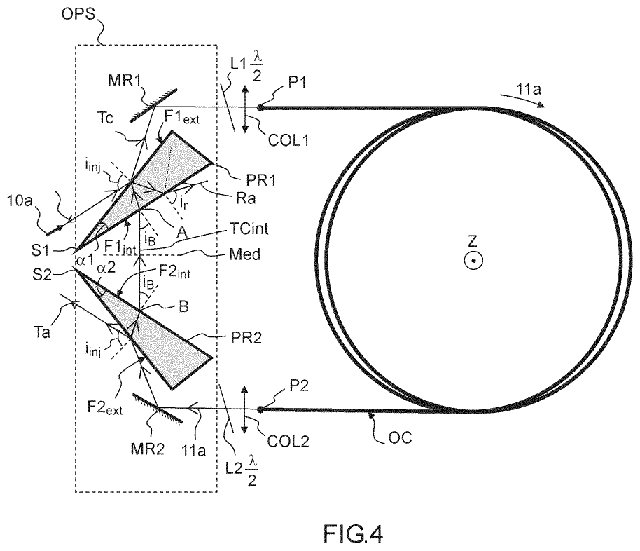

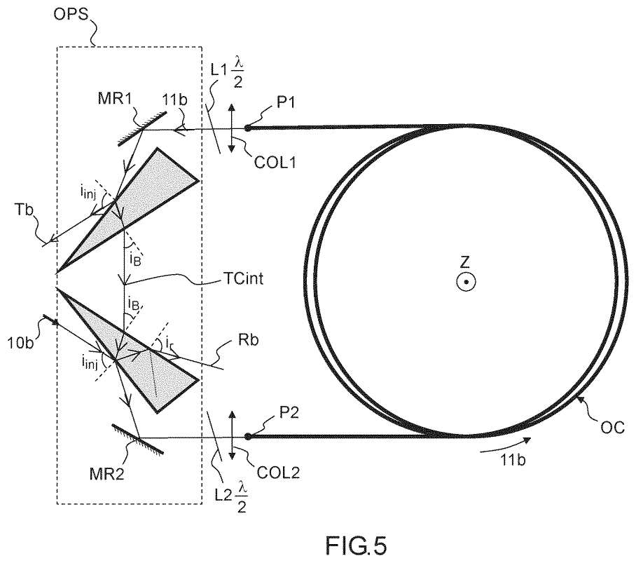

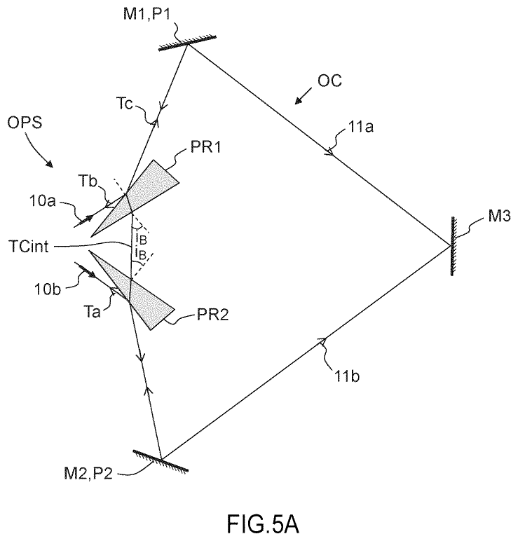

The optical system according to the invention is illustrated in FIG. 4 (for the optical path of the generic CW signal) and FIG. 5 (for the optical path of the generic CCW signal). The resonator to which OPS is coupled comprises a first port P1 and a second port P2. A first optical signal 11a and a second optical signal 11b circulate in the resonator in opposite directions.

For a fiber-optic cavity, by port what is meant is an input/output between the part of the cavity of the resonator that is not in free space (the fiber) and the part in free space that closes this cavity. The ports P1 and P2 then correspond to the ends of the fiber, as illustrated in FIGS. 4 and 5.

For a mirror cavity comprising at least three mirrors M1, M2, M3 as illustrated in FIG. 5A, in which all the propagation through the cavity is in free space, the ports P1 and P2 are not embodied by a change of propagation mode. They may for example be considered to be the points of impact of the beams on the mirrors M1 and M2 of the cavity. The cavity may comprise more than three mirrors. The “injection” into the ports within the meaning of claim 1 then corresponds to a reflection.

The optical system OPS according to the invention is coupled to the resonator OC in the sense that it is integrated into it so as to close the resonator loop.

The system OPS according to the invention comprises a first prism PR1 and a second prism PR2 placed on the common path TC of the signals 11a and 11b in free space between the two ports P1 and P2.

The first and second prisms have a first vertex S1 and a second vertex S2, respectively. For reasons of bulk or weight, according to one embodiment the prisms are truncated. In this case the vertex is virtual, i.e. it does not exist physically and corresponds to a point in space.

The first prism PR1 has a first external face F1ext configured to reflect the first incident optical signal 10a before its injection into the first port P1, and a first internal face F1int. The second prism PR2 has a second external face F2ext configured to reflect the second incident optical signal 10b before its injection into the second port P2, and a second internal face F2int. The faces F1int and F2int face each other, and the part of the common path TC located between the two internal faces F1int and F2int is called the internal part of the common path TCint. Point A is the point of impact of beam 11a on PR1 and point B is the point of impact of beam 11b on PR2. In the absence of mirrors between the two internal faces of the prisms, TCint corresponds to the segment AB.

In the configuration of the invention, the exterior beams 10a and 10b are injected into the cavity of the resonator by reflection from the external faces of the prisms, while the cavity is closed by transmission through the prisms.

Thus, the incident signal 10a is reflected by PR1 then injected/oriented via the port P1 into the resonator OC, and it then circulates in the cavity making a plurality of turns therein. The incident signal 10b is reflected by PR2 then injected via the port P2 into the resonator OC, and it then circulates in the cavity making a plurality of turns therein. Once inserted into the cavity, the beams 10a and 10b are denoted 11a and 11b. Part of the circulating signal 11a is sampled by reflection from the prism PR2 to form the first transmitted signal Ta, and likewise part of the circulating signal 11b is sampled by reflection from the prism PR1 to form the second transmitted signal Tb.

The first prism PR1 and second prism PR2 are further configured so that the internal part of the common path TCint makes, with each of the internal faces F1int, F2int, an angle equal to Brewster's angle i_{B}.

The use of Brewster prisms for the inter-prism part of the common path ensures that the two counter-propagating beams passing through the two prisms have a strictly identical polarization axis, the TM axis. There is no longer any problem with alignment of the polarizers for these two beams, a misalignment generating an optical path difference and recurring losses on each turn through the cavity. The purity of the TM wave transmitted at Brewster's incidence is much better than the purity obtained with a polarizer. In case of depolarization in the cavity or a difference between the injection polarization and the TM polarization, the TE wave sustains losses on passing through the two prisms. Furthermore, loss-free propagation of the TM-polarized optical signals 11a and 11b through the free-space part of the cavity is achieved.

Thus, use of prisms ensures that polarization-induced drift remains low without generating more losses in the cavity.

However, the losses in the cavity are critical to the sensitivity of the gyrometer incorporating the system OPS according to the invention: minimizing losses makes it possible to obtain a steep error-function slope and therefore a better sensitivity.

The portion of the wave reflected from the (injection) prism is equivalent to the wave transmitted by a mirror or a fiber-optic coupler in the state of the art. With reflection from the prism there are no losses due to scattering or absorption in matter as is the case with a mirror or coupler.

Another advantage of the two-prism configuration according to the invention is that it has a low sensitivity to temperature variations, unlike a stack of layers as employed in mirrors in the state of the art.

Furthermore, with the two-prism configuration of the invention, the wave refracted into the prism during incidence on the external face is used to collect the reflection signal, Ra for PR1 and Rb for PR2 (channel called the reflection channel).

According to one embodiment, mirrors, such as MR1 and MR2 in FIGS. 4 and 5, are positioned in the system OPS, typically for reasons of bulk. However, generally, it is sought as much as possible to avoid placing additional components on the optical path of the cavity in free space, as they would be liable to introduce losses. The mirrors MR1 and MR2 may for example be removed if the ends of the fiber are suitably oriented.

In a known manner, for a resonator comprising a fiber OF, collimators COL1 and COL2 are positioned at the exit of P1 and P2, which are the ends of the fiber. These collimators are sometimes integrated into the ends.

Also in a known manner, the polarization angle of the wave when it is injected into a hollow fiber must be equal to a predetermined value to ensure, as much as possible, that its polarization is maintained as it propagates. In this case, a half-wave plate L1λ/2 and L2λ/2 is typically inserted between the ends P1, P2 and the system OPS, so that the polarization angle on entry into the fiber has the correct value. These plates are preferably inclined, to prevent unwanted reflections.

In the general case, nothing prevents the two prisms PR1 and PR2 from having different respective refractive indices n1 and n2, this implying different values for the Brewster's angles i_{B1} and i_{B2}. However, for obvious reasons of ease of manufacture and of set-up of the optical system according to the invention, in a preferred embodiment the same material is used for both prisms and therefore the two prisms have the same refractive index np, and therefore the value of the Brewster's angle i_{B} is the same for both prisms. This case will be considered below, non-limitingly.

According to one embodiment, the first angle α1 of the vertex S1 and the second angle α2 of the vertex S2 are different. This induces a difference in value between the coefficient of reflection Rp1 (first coefficient of reflection) and the coefficient of reflection Rp2 (second coefficient of reflection) of the beams 10a and 10b from the prisms PR1 and PR2 in TM mode, respectively. The waves circulating in the cavity nevertheless have a substantially equivalent power because the respective powers of the incident beams 10a and 10b are rebalanced. The difference between Rp1 and Rp2 however allows losses on each turn to be optimized. Specifically, intra-cavity losses are due to losses intrinsic to the fiber, to losses during injection into the fiber and to the coefficients Rp1 and Rp2. Therefore, it is possible to slightly reduce the losses in the cavity (this improving the finesse of the cavity) by reducing either of the two coefficients Rp1 and Rp2. The imbalance between the counter-propagating laser powers is compensated for by the injected laser power. However, this configuration is difficult to adjust.

According to another embodiment, the first angle α1 of the vertex S1 and the second angle α2 of the vertex S2 are identical and equal to α, and thus the losses on the CW channel are equal to those on the CCW channel. This configuration is easier to adjust, the balance between the two paths occurring naturally.

Under the Brewster's-angle constraint defined above, various ways of arranging the prisms are possible, examples of which are described below non-limitingly.

FIGS. 4 and 5 illustrate a first configuration of the optical system OPS according to the invention, in which the first and second internal faces F1int and F2int of the prisms are arranged symmetrically with respect to a plane perpendicular to the plane of the common path, which corresponds to the plane of the page in FIGS. 4 and 5, which is perpendicular to the Z-axis. Typically, when TCint is equal to segment AB, this plane intersects the plane of the common path along the mediator Med of segment AB.

FIG. 5A illustrates the first configuration of the two prisms according to the invention coupled to a cavity comprising three mirrors. No collimator or half-wave plate is required in this case.

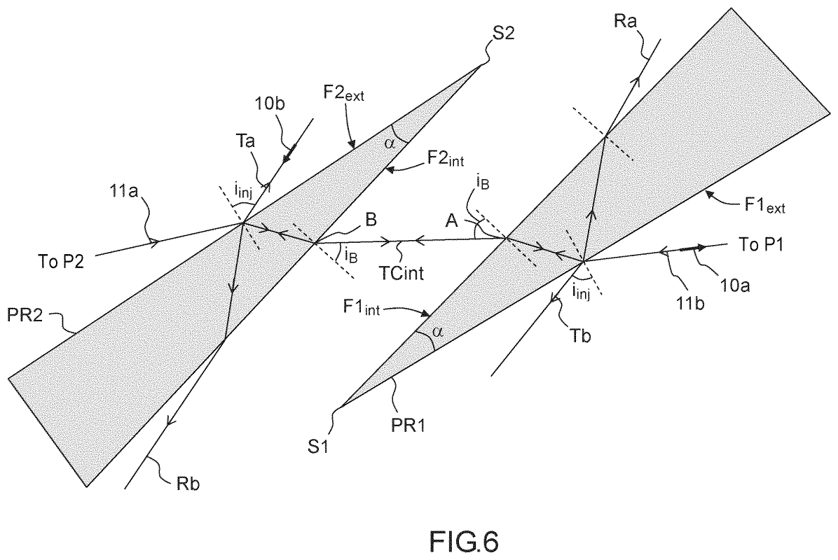

In a second configuration illustrated in FIG. 6. the first and second prisms are arranged head to tail. The internal faces F1int and F2int are then parallel to each other. The advantage of the head-to-tail configuration is that it compensates for the chromatic aberration of the prisms. The wavelength of the laser is never perfectly monochromatic and as the number of turns propagated increases the spot size of the beam increases. This effect is particularly detrimental in the case of a cavity with a hollow fiber that has a small core to which it is difficult to couple a light beam without losses. An increase in spot size increases the losses sustained coupling to the fiber.

According to a first variant illustrated in FIGS. 4 to 6, the first and second prisms are triangular-based.

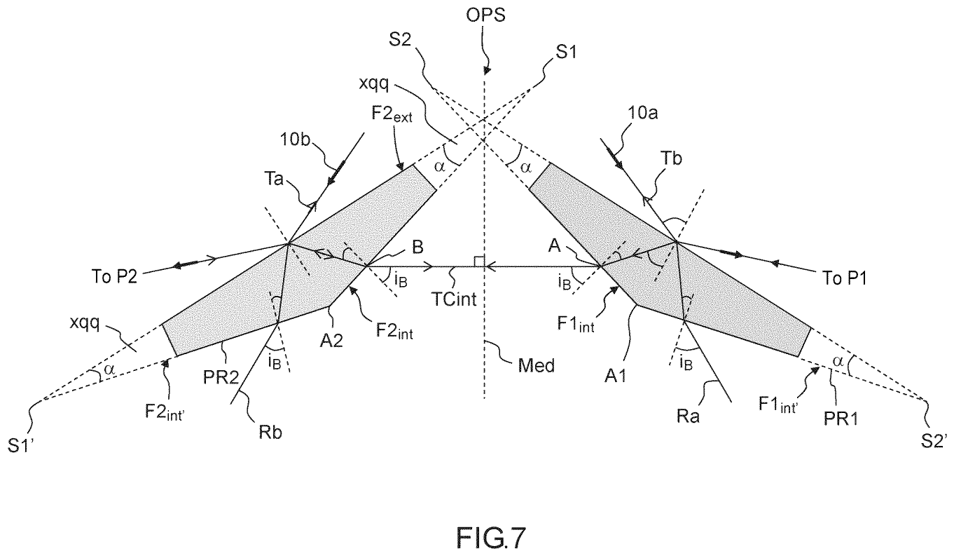

According to a second variant illustrated in FIG. 7 (first configuration) and 8 (second configuration), the first and second prisms are double prisms, each double prism having an additional vertex (S1′, S2′) having an angle identical to the angle of the corresponding vertex. It is a question of two identical prisms “joined” by their bases. The advantage of the double-prism second variant is that the reflected wave Ra, Rb is refracted on exiting the prism at Brewster's angle. For the TM mode, the parasitic internal reflections of Ra and Rb are eliminated and cavity losses due to passage through the prisms are minimized for the reflection channel.

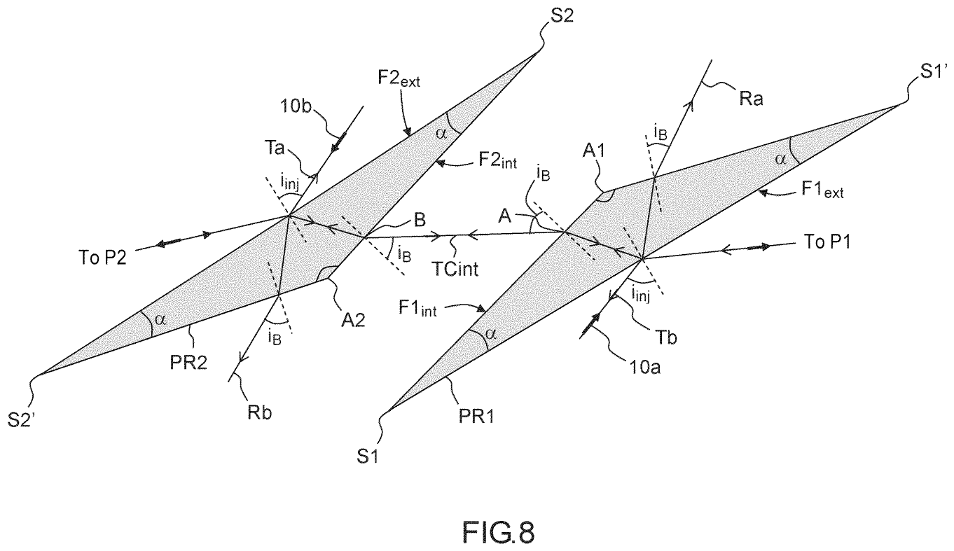

The second variant combined with the second configuration (double head-to-tail prisms (FIG. 8)) is therefore the optimal option in terms of minimization of losses and of chromatic aberration.

The embodiment in which the first and second prisms are truncated for reasons of bulk is illustrated in FIG. 7.

In a gyrometer, the degree or coefficient of coupling is defined by the fraction of the incident beam 10a, 10b that is injected into the fiber (and more generally into the cavity). This fraction must be matched to the cavity losses, these including, for a fiber-optic cavity, losses in the fiber, losses on injection into the fiber, and also losses in the optical system that closes the cavity. Thus, depending on the total cavity losses, a value of this coefficient, called the critical coupling coefficient Copt, maximizing the slope of the error function is calculated.

This coefficient Copt, which depends on the cavity losses, is typically between 1 and 5%.

The use of polarizers in the cavity, as described with respect to the state of the art, introduces losses that are difficult to estimate, adding uncertainty to the value of the optimal coupling coefficient.

When the angle α is identical for both prisms, obtainment of a predetermined value of the coefficient of reflection Rp0=r_{TM} sets the optimal vertex angle α for prisms of given refractive index np.

The refractive index np of the prisms sets Brewster's angle, which is the angle between TCint and the internal face of the prisms. Next, the vertex angle α is determined depending on the desired coupling coefficient.

The following formula, which relates r_{TM} and α, has been established:

$$α = {cos}^{- 1} ( \sqrt{\frac{1 - {( \frac{{n}_{2}}{{n}_{1}} )}^{2}}{{( \frac{{n}_{2}}{{n}_{1}} \cdot \frac{1 - {r}_{TM}}{1 + {r}_{TM}} )}^{2} - {( \frac{{n}_{2}}{{n}_{1}} )}^{2}}} ) - {tan}^{- 1} ( \frac{{n}_{2}}{{n}_{1}} )$$

with n1=the index of air and n2=np.

The injection angle iᵢₙⱼ is determined by the following formula:

$${n}_{1} sin ( {i}_{inj} ) = {n}_{2} sin ( α - {i}_{B} + \frac{π}{2} )$$

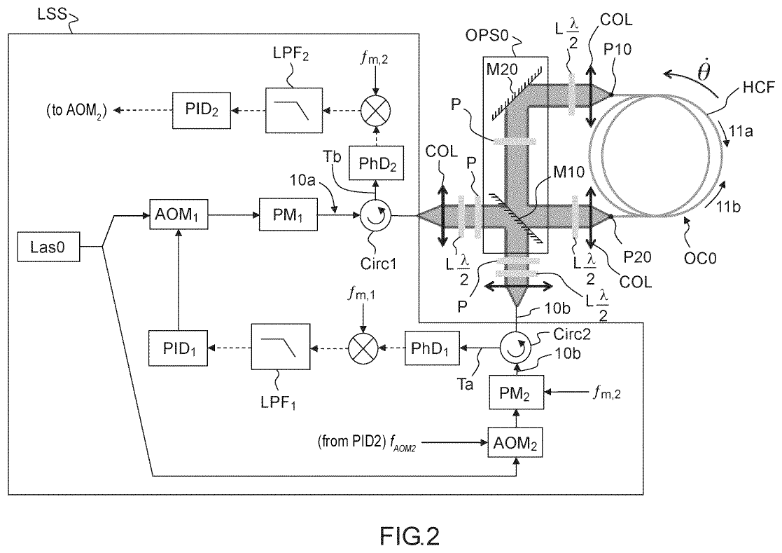

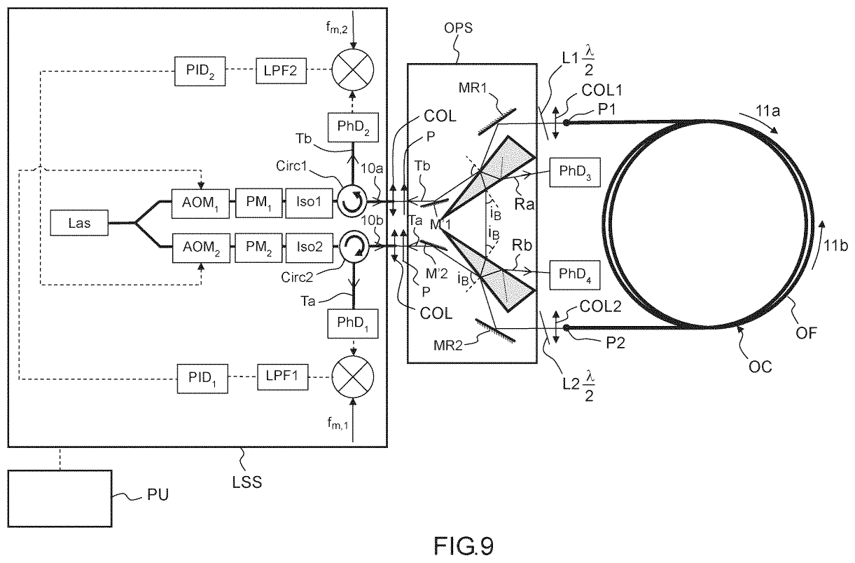

The invention also relates to a passive resonant gyrometer 10, one example of which is illustrated in FIG. 9. The gyrometer 10 illustrated in this figure is of the same type as that illustrated in FIG. 2, with the incident beams 10a, 10b and resonator coupled by an optical system according to the invention instead of the two mirrors M10 and M20.

The gyrometer 10 comprises a coherent source system LSS configured to generate the first incident optical signal 10a and the second incident optical signal 10b. It will be recalled that these two signals are frequency shifted (see the state of the art). The gyrometer also comprises the resonator OC and an optical system OPS according to the invention as described above coupled to the resonator. The source system LSS comprises at least a first photodetector PD1 and a second photodetector PD2, which photodetectors are configured to detect optical signals extracted from the resonator OC via said optical system OPS. The gyrometer also comprises control and servo electronics for achieving the frequency shift, and for probing this shift as a function of time to determine a measurement of angle or of angular velocity.

The gyrometer lastly comprises a processing unit PU configured to determine an angle of rotation Q or a velocity of rotation \vec{θ} about a Z-axis based on the electrical signals generated by the photodetectors.

The gyrometer according to the invention may be a 2-, 3- or 4-wave gyrometer, the waves being generated with one or more lasers, the gyrometer being driven with control and servo electronics according to techniques known to those skilled in the art.

According to one embodiment, the resonator is a cavity with at least three mirrors. A cavity with 3 mirrors M1, M2 and M3 is illustrated in FIG. 5A. A cavity with four mirrors typically involves a rectangular arrangement of the mirrors M1, M2, M3 and M4.

According to another embodiment, the resonator is an optical fiber OF as illustrated in FIG. 9. According to one embodiment, the fiber is wound into a coil, as also illustrated in FIG. 9.

According to one embodiment the fiber has a solid core, and according to another embodiment the fiber has a hollow core. A gyrometer according to the invention with this type of hollow-core fiber is particularly advantageous because the intrinsic losses of the hollow-core fiber and the losses during injection into the fiber are quite high and limit the maximum finesse value. It is therefore important to minimize losses in the loop-closing optics, this being fully achieved through use of Brewster's angle to the internal face of the prism. In addition, there is currently no polarization-maintaining hollow-core fiber with characteristics compatible with application to a gyrometer, this making it necessary to finely control intra-cavity polarization. Use of Brewster's angle ensures a fine adjustment of the intra-cavity polarization.

Examples of hollow-core fibers are given non-limitingly with respect to the state of the art.

FIG. 9 illustrates a gyrometer in which the two signals 10a and 10b are generated by a single laser L split into 2 channels. Each channel comprises an acousto-optic modulator (AOM1, AOM2) for the frequency shift and a phase modulator (PM1, PM2) for the modulation of each of the counter-propagating waves, this allowing the two waves to be servo-controlled to their respective cavities. An isolator (Iso1, Iso2) prevents signals backscattered by the cavity from reaching the laser source.

Circulators Circ1 and Circ2 distribute the signals 10a, 10b to the cavity and the signals Ta, Tb to the photodetectors PhD1 and PhD2. The assembly AOM/PM/Iso/Circ is fiber-optic and each channel also comprises a collimator COL at the exit of the fiber and a polarizer P that ensures the beams incident on the prisms have a TM polarization. The gyrometer also comprises steering mirrors MR1, MR2, M′1 and M′2.

The control and servo electronics comprise, for each detected channel, a mixer with a frequency fm,1, fm,2, a low-pass filter LPF1, LPF2, and a corrector PID1, PID2 which feeds back to the associated acousto-optic modulator AOM1, AOM2.

The reflected signals Ra and Rb are collected by two photodetectors PhD3 and PhD4. These detectors of the reflected channels may be used to servo-control the gyrometer instead of servo-control on the transmitted channels via the photodetectors PhD1 and PhD2.

This listing of claims replaces all prior versions, and listings of claims in the application:

1. An optical system (OPS) intended to be coupled to an optical resonator (OC), the optical resonator comprising a first port (P1) and a second port (P2) and being configured so that a first optical signal and a second optical signal circulate in opposite directions, the optical system comprising:
a first prism (PR1) and a second prism (PR2), which prisms are placed on a path (TC) through free space common to the first and second signals between the two ports, the first prism and second prism respectively having:
a first external face (F1ext) and a second external face (F2ext), which faces are configured to reflect a first incident optical signal and a second incident optical signal, respectively, before their injection into the first port (P1) and the second port (P2), respectively;
a first internal face (F lint) and a second internal face (F2int) facing each other, part of the common path (TC) located between the two internal faces being called the internal part of the common path (TCint),
the first and second prisms further being configured so that the internal part of the common path (TCint) makes, with each of the internal faces (F1int, F2int), an angle equal to Brewster's angle (i_{B}).

2. The optical system as claimed in claim 1, wherein the first prism and the second prism have a first vertex (S1) and a second vertex (S2), respectively, having a first angle (α1) and a second angle (α2) that are different, respectively.

3. The optical system as claimed in claim 1, wherein the first prism and the second prism have a first vertex (S1) and a second vertex (S2), respectively, having a first angle and a second angle (α) that are identical, respectively.

4. The optical system as claimed in claim 1, wherein the first and second internal faces of the prisms are arranged symmetrically about a plane perpendicular to the plane of the common path.

5. The optical system as claimed in claim 1, wherein the first and second prisms are arranged head to tail.

6. The optical system as claimed in claim 1, wherein the first and second prisms are triangular-based.

7. The optical system as claimed in claim 1, wherein the first and second prisms are double prisms, each double prism having an additional vertex (S1′, S2′) having an angle identical to the angle of the corresponding vertex.

8. The optical system as claimed in claim 1, wherein the first and/or second prisms are truncated.

9. The optical system as claimed in claim 2, wherein the first angle is determined so as to obtain a predetermined first coefficient of reflection (Rp1) for the first optical signal from the first external face (F1ext) and a predetermined second coefficient of reflection (Rp2) for the second optical signal (F2ext) from the second external face, respectively.

10. A gyrometer (49) comprising:
a coherent source system (LSS) configured to generate the first incident optical signal and the second incident optical signal;
the optical resonator (OC);
an optical system (OPS) as claimed in any of the preceding claims coupled to
the optical resonator,
the source system comprising at least a first photodetector (PD1) and a second photodetector (PD2), which photodetectors are configured to detect optical signals extracted from said resonator via said optical system, and control and servo electronics;
a processing unit (PU) configured to determine an angle and/or a velocity of rotation about a Z-axis based on the electrical signals generated by said detectors.

11. The gyrometer as claimed in claim 10, wherein the resonator is a cavity comprising at least three mirrors.

12. The gyrometer as claimed in claim 10, wherein the resonator is an optical fiber.

13. The gyrometer as claimed in claim 12, wherein the fiber is wound into a coil.

14. The gyrometer as claimed in claim 13, wherein the optical fiber is a hollow-core fiber.
